(19) United States
(12) Patent Application Publication
(10) Pub. No.: US 2008/0145721 A1
(43) Pub. Date: Jun. 19, 2008

(54) FUEL CELL APPARATUS AND ASSOCIATED METHOD

(75) Inventors: Andrew Philip Shapiro, Schenectady, NY (US); Richard Louis Hart, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/675,399

(22) Filed: Feb. 15, 2007

Related U.S. Application Data
(60) Provisional application No. 60/869,948, filed on Dec. 14, 2006.

(51) Int. Cl. H01M 8/00

(52) U.S. Cl. 429/13; 429/34

(57) ABSTRACT

A fuel cell apparatus is provided that includes an electrochemical energy conversion device comprising an anode and a cathode. The cathode receives an air gas stream flowing thereto. The apparatus further includes a humidity exchange component and a gas scrubber component. The humidity exchange component controls a humidity level in the gas stream flowing toward the cathode. The gas scrubber component includes an active material that reduces a carbon dioxide content level from the air gas stream. A method of using the apparatus is provided.

### CROSS REFERENCE TO RELATED APPLICATIONS

This application claims the priority and benefit of U.S. Provisional Application No. 60/869,948, entitled “FUEL CELL APPARATUS AND ASSOCIATED METHOD” filed on Dec. 14, 2006, which is incorporated herein by reference in its entirety.

### TECHNICAL FIELD

The invention includes embodiments that relate to an apparatus including a fuel cell. The invention includes embodiments that relate to a method of using the fuel cell.

### DISCUSSION OF RELATED ART

An electrochemical cell may convert the chemical energy of a fuel directly into electricity without any intermediate thermal or mechanical processes. Energy may be released when a fuel reacts chemically with oxygen in the air. A fuel cell may convert hydrogen and oxygen into water. The conversion reaction occurs electrochemically and the energy may be released as a combination of electrical energy and heat. The electrical energy can do useful work directly, while the heat may be dispersed.

A rechargeable fuel cell may be a fuel cell using a hydrogen storage material as an anode and an air electrode as a cathode. The hydrogen storage material functions as both a hydrogen source for fuel and as a hydrogen oxidization catalyst. Water may be employed as an energy transformation media. When electricity is charged in the rechargeable fuel cell, water may be electrolyzed into hydrogen and oxygen. The produced hydrogen may be stored in hydrogen storage material, the anode. In reverse, when the electricity is applied to the loads, the hydrogen from the anode and oxygen from air constitute a fuel cell to deliver electricity. Because of the unlimited supply of fresh air, the energy stored in the rechargeable fuel cell depends on the capacity of the anode. This functionality may avoid the need for a high-pressure hydrogen container and allows for higher energy density.

It may be desirable to have a fuel cell having differing characteristics or properties than those fuel cells that are currently available. It may be desirable to have a method of using a fuel cell that differs from those methods that are currently available.

### BRIEF DESCRIPTION

In accordance with an embodiment of the invention, an apparatus is provided. The apparatus includes an electrochemical energy conversion device comprising an anode and a cathode. The cathode receives an air gas stream flowing thereto. The apparatus further includes a humidity exchange component and a gas scrubber component. The humidity exchange component controls a humidity level in the gas stream flowing toward the cathode. The gas scrubber component includes an active material that reduces a carbon dioxide content level from the air gas stream.

In one embodiment, a method is provided that includes contacting ambient air to a humidity buffer to control the humidity level of an air gas stream flowing from the ambient air toward an electrode in an electrochemical cell. The air gas stream is contacted to an active material layer, and the ambient air comprises a target gas, carbon dioxide, and the active material layer comprises an amidine. The method includes binding the carbon dioxide to the amidine and flowing the air gas stream, which is free of the target gas, toward the electrode.

In one aspect, the method can include contacting the air gas stream to an active material layer in a first gas scrubber module during a first operation mode, and contacting the air gas stream to an active material layer in a second gas scrubber module during a second operation mode. The mode of operation can be switched from the first operation mode to the second operation mode, and back again.

In another embodiment, an apparatus is provided that includes an electrochemical cell comprising an air electrode that receives an intake air gas stream. The apparatus also includes means for maintaining a defined relative humidity of the intake air gas stream to be in a range of from about 50 percent to about 90 percent; and means for reducing or eliminating carbon dioxide from the air gas stream.

In one embodiment a humidity exchange device is used to transfer humidity from the exhaust air leaving the fuel cell stack to the inlet air prior to contacting the carbon dioxide scrubber. The humidity exchanger is comprised of a membrane that selectively passes water vapor, as opposed to oxygen, from the stream of higher concentration to the stream of lower concentration.

### BRIEF DISCUSSION OF DRAWINGS

FIG. 1 is a schematic side view of an apparatus according to one embodiment of the invention.

### DETAILED DESCRIPTION

The invention includes embodiments that relate to a fuel cell apparatus. The invention includes embodiments that relate to a method of using the fuel cell apparatus.

Approximating language, as used herein throughout the specification and claims, may be applied to modify any quantitative representation that could permissibly vary without resulting in a change in the basic function to which it may be about related. Accordingly, a value modified by a term such as “about” is not limited to the precise value specified. In some instances, the approximating language may correspond to the precision of an instrument for measuring the value.

As used herein, a membrane refers either to a selective membrane that is a selective barrier that permits passage of water vapor but not oxygen, or to an ion selective membrane that is a selective barrier that permits passage of ions generated at the cathode through the membrane to the anode for oxidation of hydrogen at the anode to form water and heat, unless context or language indicates otherwise. The terms anode and anodic electrode refer to an electrode that may be fabricated from metal hydride materials. Suitable metal hydride anode materials may include LaNi₅ and TiNi types of alloys.

The terms cathode and cathodic electrode refer to an electrode that may be fabricated from carbon, metal, or a metal oxide and may include a catalyst. The cathode in the fuel cell embodiments described herein, is, for some embodiments, graphite or other carbon-based support material. At the cathode or cathodic electrode, oxygen from air is reduced by free electrons from the usable electric current, generated at the anode, that combine with water, to form hydroxide ions and heat. Suitable fuel cells may include a rechargeable fuel cell, an alkaline fuel cell, or a metal/air battery.

The term humidity buffer solution includes a composition of matter that is capable of absorbing excess water from or adding replacement water to a selected electrolyte solution. This capability may include producing and maintaining an equilibrium humidity at or near that of the selected electrolyte solution. Some humidity buffer solutions may comprise aqueous solutions of one or more organic or inorganic salts. Furthermore, the solvent is not limited to water alone. Water may be combined with any of a wide variety of soluble or semi-soluble additives.

According to one embodiment, an apparatus is provided that includes a housing, a plurality of electrodes, a supporting electrolyte, and a membrane. The plurality of electrodes may include an anode, a cathode, and an optional 3^{rd} electrode. The membrane may be an electrically-insulating and ion-conducting membrane that separates the anode from the cathode. The cathode receives a flow or stream of air gas. The air gas stream provides oxidant (e.g., oxygen) to the cathode during use. Prior to the air gas stream contacting the cathode, at least two components of the apparatus interact with the air gas stream. The two components include a humidity exchange component, and a gas scrubber component. The two components are discussed in further detail herein below.

On the anode side, hydrogen reacts with hydroxyl ion in electrolyte producing electrons and water molecules. The electrons are forced to travel in an external circuit (supplying power) because the membrane is electronically insulating. The cathode may be in contact with ambient air, and may include an optional catalyst. The cathode catalyst contacts oxygen molecules with the electrons that have traveled through the external circuit and water to generate hydroxyl ions.

In one embodiment, the housing wall has an inner surface and an outer surface. The inner and outer surfaces of the wall define the apertures that are capable of passing fluid therethrough. As used herein, apertures include holes, pores, mesh and the like. The shape and size of the apertures may be selected with reference to such factors as desired flow rate of the oxidant and end use application. The inner surface of the wall defines a volume.

In one embodiment, each of the plurality of the electrodes may be configured as cylinders or as plates. The plurality of electrodes includes a first electrode, a second electrode and a third electrode. The second electrode is in ionic communication with each of the first electrode and third electrode.

The first electrode may be a cathode, for example, a cathodic air electrode. The air electrode consumes oxygen from outside ambient air during discharge, and generates oxygen during charge operation of the fuel cell. The air electrode can be made of carbon matrix and a catalyst. The cathode catalyst accelerates dissociation of molecular oxygen into atomic oxygen. In other words, oxygen from air is reduced at the air electrode and, consumed free electrons conduct through the external circuit. The catalyst may include metals or metal oxide selected from platinum, palladium, ruthenium, silver, manganese dioxide, nickel oxide, cobalt oxide, perovskite oxide, or a combination of two or more thereof.

The second electrode may be an anode. The anode or negative electrode may act as both a hydrogen oxidization catalyst or as a hydrogen storage media. The anode includes a hydrogen storage material capable of receiving, storing and releasing hydrogen. The anode embodiments may include an active material supported on a current collector grid. The active material for the anode may include a hydrogen storage material, a binder material, and graphite or graphitized carbon. Other suitable active materials may include metals such as nickel, and metal oxides such as nickel oxide. Suitable nickel metal may be the commercially available trademark RANEY nickel. Suitable hydrogen storage material may be selected from hydride complexes, aluminides, borides, carbides, germanides, and silicides, or a combination of two or more thereof.

Suitable hydride complexes may include a H-M complex, where M is a metal and H is hydrogen. Such hydrides may have ionic, covalent, metallic bonding or bonding including a combination of at least one of the foregoing types of bonding. These hydrides have a hydrogen to metal ratio of greater than or equal to 1. The reaction between a metal and hydrogen to form a hydride may be a reversible reaction and takes place according to the following equation (VI):

M+(x/2) H₂ [symbol] MHx (VI)

Hydride complexes can store up to 18 weight percent of hydrogen, and have high volumetric storage densities. The volumetric storage density of hydrides may be greater than either liquid or solid hydrogen, which makes them very useful in energy storage applications. The process of hydrogen adsorption, absorption or chemisorption results in hydrogen storage and may be hereinafter referred to as absorption, while the process of desorption results in the release of hydrogen.

Suitable metal hydrides include but are not limited to Ni, Co, Al, Mn, Mo, Ti, Zn, Rh, Ru, Ir, La, Ni, Fe, Ti, Zr, W, V, B and alloys of these materials. The alloys may be selected from Rare-earth metal alloys, Misch metal alloys, zirconium alloys, titanium alloys, magnesium/nickel alloys, and mixtures or alloys thereof which may be AB, AB₂, A₂B, AB₃ or AB₅ type alloys. Such alloys may include modifier elements to increase their hydrogen storage capability.

Suitable aluminides compositions may include one or more of AlLi, Al₂Li₃, Al₄Li₉, Al₃Mg₂, Al₁₂Mg₁₇, AlB₁₂, Al₄C₃, AlTi₂C, AlTi₃C, AlZrC₂, Al₃Zr₂C₄, A₁₃Zr₂C₇, AlB₂, AlB₁₂, and AlSi. Suitable boride compositions may include one or more of AlB₂, AlB₁₂, B₆Ca, B₆K, B₁₂Li, B₆Li, B₄Li, B₃Li, B₂Li, BLi, B₆Li₇, Bli₃, MgB₂, MgB₄, MgB₇, NaB₆, NaB₁₅, and NaB₁₆. Suitable carbide compositions may include one or more of Al₄C₃, Na₄C₃, Li₄C₃, K₄C₃, LiC, LiC₆, Mg₂C₃, MgC₂, AlTi₂C, AlTi₃C, AlZrC₂, Al₃Zr₅C, Al₃Zr₂C₄, Al₃Zr₂C₇, KC₄, and NaC₄. Suitable germanide compositions may include one or more of Ge₄K, GeK, GeK₃, GeLi₃, Ge₅Li₂₂, Mg₂Ge, Ge₄Na, GeNa, and GeNa₃. Suitable siliconide compositions may include one or more of AlSi, Ca₂Si, CaSi, CaSi₂, KSi, K₄Si₂₃, Li₂₂Si₅, Li₁₃S₄, Li₇Si₃, Li₁₂Si₇, Mg₂Si, NaSi, NaSi₂, and Na₄Si₂₃.

The anode is disposed on an imaginary line defined by the air electrode and the third electrode. That is, the anode is located between the other electrodes. In one embodiment, the anode may be separated from the other electrodes by a porous matrix. The porous matrix may be a zeolite, membrane or gel placed in between the anode and each of the air electrode and the third electrode. The porous matrix may be a membrane saturated with an aqueous alkaline solution, such as potassium hydroxide (KOH). Other electrolytes suitable for use in the fuel cell may include alkaline hydroxides or salt solutions. The membrane helps to physically segregate the hydrogen and oxidant to avoid direct combustion as well as provides ionic communication.

The third electrode may be a charging electrode capable of moving the location of oxygen evolution during charging away from the first electrode. The third electrode may be used as positive electrode, and charging of the fuel cell takes place between the anode and the third electrode. The third electrode may be similar to a positive electrode as used in a NiMH cell. The third electrode may be made of ferro-based alloys. Suitable ferro-based alloys may include stainless steel. Suitable materials may further include one or more of nickel, cadmium, palladium, lead, gold, or platinum. The third electrode may be configured as sintered type, foamed type, fiber type or the like. Such configuration may provide an increased surface area for reaction, may enhance an ability of storing electrolyte solution within the volume of its pores and may provide diffusion control. A sintered-type nickel electrode, when used as the charging electrode, is suitable in life span. On the other hand, a foamed-type nickel electrode as well as a fiber-type nickel electrode, when used as the charging electrode, is suitable for relatively high capacity.

In one embodiment, the third electrode may include both nickel and nickel hydroxide. Nickel hydroxide provides high catalytic activity and large reactive area, which helps to charge the fuel cell at lower charging voltage to reduce the loss of energy. Chemical activity may be defined as the ability of a substance to accelerate a chemical reaction in presence of the substance.

Suitable amount of nickel hydroxide in third electrode may be greater than about 10 weight percent. In one embodiment, the amount may be in a range of from about 10 weight percent to about 20 weight percent, from about 20 weight percent to about 30 weight percent, from about 30 weight percent to about 40 weight percent, from about 40 weight percent to about 50 weight percent, from about 50 weight percent to about 60 weight percent, or from about 60 weight percent to about 100 weight percent.

In one embodiment, the third electrode may be a supercapacitor electrode. A “supercapacitor” has a large capacitance and stores a large amount of energy in a small volume. Capacitance is proportional to the surface area of the electrodes divided by their separation distance. Simple capacitors consisting of two parallel plates reach small capacitances of the order of pico-Farad (1 pF=10⁻¹² F). When such a capacitor is loaded to 1000 V, the energy content is on the order of micro-watt-second (Ws). Increasing the surface area of electrodes and minimizing the separation distance to a molecular range provides large capacitance. Capacitance of a supercapacitor is in a range of from about 10⁻⁶ farad to about 10³ Farad and stores energy in a range of from about 10⁻³ Ws to Watt-hour (Wh).

The supercapacitor electrode may be a large surface area porous electrode. The porous electrode may include a porous portion and a substrate. The substrate may be formed as a plate, a mesh, a foil, a sheet or the like. The substrate may be made of a conductive material or a non-conductive material. Suitable conductive material may include a metal such as ferro-based metal (e.g., stainless steel), titanium, platinum, iridium, or rhodium. Other suitable conductive material may be organic, such as a conductive plastic or graphite. The substrate may be non-conductive, if it is further coated with a conductive material. The conductive coating may be a one of the foregoing conductive materials.

Suitable material for use as the porous portion include one or more of carbon nanotubes, graphite, carbon fiber, carbon cloth, carbon aerogel, or a conductive polymer. Other suitable material for use as the porous portion may be selected from metallic powder or metal oxide.

In one embodiment, the porosity of the porous portion may be greater than about 10 percent. In another embodiment, the porosity of the porous portion may be in a range of from about 10 percent to about 20 percent, from about 20 percent to about 30 percent, from about 30 percent to about 40 percent, from about 40 percent to about 50 percent, or from about 50 percent to about 60 percent. In one embodiment, the pore size of the porous portion may be greater than about 1 nanometer. In one embodiment, the pore size of the porous portion may be in a range of from 1 nanometer to about 10 nanometers, from about 10 nanometers to about 20 nanometers, from about 20 nanometers to about 500 nanometers, or about 500 nanometers to about 1000 nanometers.

As noted, the third electrode may be formed from a supercapacitor electrode material. The amount of supercapacitor electrode material in the third electrode may be greater than about 10 weight percent. In one embodiment, the amount may be in a range of from about 10 weight percent to about 20 weight percent, from about 20 weight percent to about 30 weight percent, from about 30 weight percent to about 40 weight percent, from about 40 weight percent to about 50 weight percent, from about 50 weight percent to about 60 weight percent, or from about 60 weight percent to 100 weight percent.

With regard to the ion exchange membrane, suitable material may include one or more of polytetrafluoroethylene, polysulphone, polyphenylene oxide, polybenzimidazole, or polyetherimide. Polybenzimidazole is commercially available from Celanese Corporation Headquarters (Dallas, Tex.). These materials may be expanded, porous, perforated, or drawn as fibers to form a mesh, weave or mat. In one embodiment, the material may be drawn as a hollow fiber. Also, the material may be surface treated to affect such properties and characteristics as hydrophobicity/hydrophilicity, anti-fouling, electrical resistivity, ion permeability, chemical resistance, and water repellency.

Suitable thickness of the ion exchange membrane may be greater than about 10 nanometers. In one embodiment, the thickness of the ion exchange membrane may be in a range of from about 10 nanometers to about 100 nanometers, from 100 nanometers to about 1 micrometer, from about 1 micrometer to about 10 micrometers, from about 10 micrometers to about 100 micrometers, from about 100 micrometer to about 1 millimeter, or greater than 1 millimeter. In one embodiment, the thickness of ion exchange membrane is in a range of from about 20 micrometers to about 200 micrometers. The ion exchange membrane may be characterized by one or more properties. The properties may include pore size. In one embodiment, the pore size may be in a range of from about 1 nanometer to about 10 nanometers, from about 10 nanometers to about 100 nanometers, from about 100 nanometers to about 1 micrometer, from about 1 micrometer to about 10 micrometers. Naturally, the thickness, pores size, pore configuration, and any surface treatments may cooperate to control such properties as flow rate, flow selectivity, and performance.

There are several regions within the volume. A region is defined as the space that exists between the inner surface of the wall and a surface of an adjacent electrode. A first region is bounded by the inner surface of one wall and the adjacent air electrode. A second region is bounded by the inner surface of the other wall and the adjacent third electrode. Disposed in one or more regions may be a separator. A separator may be a hydrophobic or superhydrophobic membrane (differing from the ion exchange membrane discussed herein). Superhydrophobic is a quality defined as a surface having repellency for liquid/water or a surface that does not get wet when dipped into or placed in contact of water/liquid or that has a contact angle with water drop greater than 150 degrees. The separator prevents liquid from passing through while allowing air/oxygen to pass there through.

The active material layer in the gas scrubber component may include one or more active materials that are capable of chemically and/or physically binding a target gas. Suitable active materials may include one or more of amines, amidines, or polymers or composites that include such nitrogen-based functionality. Copolymers and blends of the active molecules or polymers can also be utilized in the invention. In one embodiment, the active material may include one or more of an amine, a pyrimidine, or an amide functional group.

Suitable amines may include one or more alkyl ethanolamine. Suitable alkyl ethanolamine may include one or more of triethanolamine (TEA), monoethanolamine (MEA), diethanolamine (DEA), or methyl diethanolamine (MDEA). Other suitable amines may include propanolamines, or other longer chain alkanes having a hydroxyl functionality and an amine functionality. Both primary and secondary amines may be utilized. In one embodiment, the active material may include polyamine functionality. Suitable amines may be commercially obtained from Dow Chemical (Midland, Mich.). Unless specified otherwise, all ingredients are commercially available from such common chemical suppliers as Alpha Aesar, Inc. (Ward Hill, Mass.), Sigma-Aldrich Company (St. Louis, Mo.), and the like.

Suitable amidines may include one or more of 1,8-diazabicyclo (5.4.0)-undec -7-ene (DBU), tetrahydropyrimidine (THP), N-methyltetrahydropyrimidine (MTHP). Other suitable amidines may include polystyrene, polymethacrylate, polyacrylate, polycarbonate, polyimide, polyetherimide, or polyarylene oxide that has modified by DBU, THP or MTHP. In one embodiment, the amidine may include one or more of a bis-amidine, tris-amidine, or tetra-amidine, or a salt of any of these.

Other suitable active material includes polyethyleneimine (PEI). In one embodiment, the polyethyleneimine is a random branched form of the polymer containing at least one of primary, secondary, and tertiary amines. Suitable molecular weights for PEI materials may be greater than 400 MW. In one embodiment, the PEI molecular weight may be in a range of from about 400 MW to about 500 MW, from about 600 MW to about 700 MW, from about 700 MW to about 800 MW, from about 800 MW to about 900 MW, or greater than about 900 MW. In one embodiment, the PEI is supported on granular activated carbon (20-30 mesh) having ultra high internal surface area. Suitable methods of forming may include diluting PEI with a low molecular weight alcohol, e.g., methanol, dispersing the PEI solution onto the carbon, and allowing the solvent to evaporate. Factors that influence the material type and molecular weight selection process include viscosity (lower being better), volatility (again, lower being better), and performance over time.

In one embodiment, the active polymer may be produced through radical polymerization, cationic polymerization, anionic polymerization, group transfer polymerization, ring-opening polymerization, ring-open metathesis polymerization, coordination polymerization, condensation polymerization, etc. The active polymer may be also produced by modification of a pre-made polymer structure using suitable active molecules. In one embodiment, the amidine may include a compound having the general formula X—Y(Z)n. In this formula, X is a moiety as shown in Formula I:

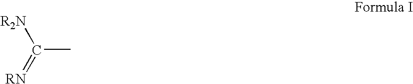

wherein each R is, independently, hydrogen, an optionally substituted alkyl, alkenyl, aryl, alkaryl, or alkenylaryl group. Y is a bond or a linking group. Z is hydrogen or a second moiety according to Formula I, which may be the same or different than X, and n is an integer from 1 to 3.

Alkyl means an aliphatic hydrocarbon group that may be linear or branched having from 1 to about 15 carbon atoms, in some embodiments 1 to about 10 carbon atoms. Branched means that one or more lower alkyl groups such as methyl, ethyl, or propyl are attached to a linear alkyl chain. Lower alkyl means having 1 to about 6 carbon atoms in the chain, which may be linear or branched. One or more halo atoms, cycloalkyl, or cycloalkenyl groups may be a substitute for the alkyl group.

Alkenyl means an aliphatic hydrocarbon group containing a carbon-carbon double bond and which may be straight or branched having 2 to about 15 carbon atoms in the chain. Preferred alkenyl groups have 2 to about 10 carbon atoms in the chain, and more preferably 2 to about 6 carbon atoms in the chain. Lower alkenyl means 2 to about 4 carbon atoms in the chain, which may be straight or branched. The alkenyl group may be substituted by one or more halo atoms, cycloalkyl, or cycloalkenyl groups. Cycloalkyl means a non-aromatic mono- or multicyclic ring system of about 3 to about 12 carbon atoms. Exemplary cycloalkyl rings include cyclopentyl, cyclohexyl, and cycloheptyl. The cycloalkyl group may be substituted by one or more halo atoms, methylene, alkyl, cycloalkyl, heterocyclyl, aralkyl, heteroaralkyl, aryl or heteroaryl. Hetero means oxygen, nitrogen, or sulfur in place of one or more carbon atoms. Cycloalkenyl means a non-aromatic monocyclic or multicyclic ring system containing a carbon-carbon double bond and having about 3 to about 10 carbon atoms. The cycloalkenyl group may be substituted by one or more halo atoms, or methylene, alkyl, cycloalkyl, heterocyclyl, aralkyl, heteroaralkyl, aryl, or heteroaryl groups.

Aryl means an aromatic carbocyclic radical containing about 6 to about 12 carbon atoms. Exemplary aryl groups include phenyl or naphthyl optionally substituted with one or more aryl group substituents which may be the same or different, where “aryl group substituent” includes hydrogen, alkyl, cycloalkyl, optionally substituted aryl, optionally substituted heteroaryl, aralkyl, aralkenyl, aralkynyl, heteroaralkyl, heteroaralkenyl, heteroaralkynyl, hydroxy, hydroxyalkyl, alkoxy, aryloxy, aralkoxy, carboxy, acyl, aroyl, halo, nitro, cyano, carboxy, alkoxycarbonyl, aryloxycarbonyl, aralkoxycarbonyl, acylamino, aroylamino, alkylsulfonyl, arylsulfonyl, and other known groups. Alkaryl means an aryl-alkyl-group in which the aryl and alkyl are as previously described. Alkenylaryl means an aryl-alkenyl-group in which the aryl and alkenyl are as previously described.

In the general formula X—Y(Z)n, Y can be a bond or a linking group R′, which may be, or include, a hetero-atom such as oxygen, sulfur, phosphorous, or nitrogen, and the like. The linking group R′ may be an alkyl, alkenyl, aryl, or alkaryl group having from 1 to about 15 carbon atoms, which may be linear or branched, and which may be non-fluorinated, fluorinated, or perfluorinated. n is greater than 1. In one embodiment, the amidine may include one or more carboxylate salts of an amidine, which amidine and/or salt optionally can be fluorinated or perfluorinated.

The carbon dioxide may react with the active materials to form such products as zwitterions adducts and ammonium carbamate, for example. Active materials may be selected based on the ability to physically bind a target gas, which if carbon dioxide may include carbon fiber compounds and their composites. For example, carbon fiber composite molecular sieve (CFCMS) can adsorb carbon dioxide. Other suitable materials for physical binding of a target gas may include carbon nanotubes, buckyballs or fullerenes, porous ceramics, zeolites, and the like.

Such active materials can adsorb carbon dioxide in low temperatures during the discharge process of the galvanic cell by either a chemical reaction, physical adsorption or both. The active materials can be regenerated within the active material layer by applying a thermal treatment in the range of greater than about 65 degrees Celsius to the resistance coil during the charge period of an electrochemical cell. In one embodiment, the thermal treatment may be less than about 120 degrees Celsius. Further, the temperature range may be from about 65 degrees Celsius to about 80 degrees Celsius, from about 80 degrees Celsius to about 100 degrees Celsius, from about 100 degrees Celsius to about 110 degrees Celsius, or from about 110 degrees Celsius to about 120 degrees Celsius. Alternatively or additionally, applying a low voltage to a resistance coil heater proximate to the gas scrubber may regenerate the active material therein.

The humidity exchange component serves to transfer humidity from the exhaust air stream leaving the fuel cell stack with the incoming air stream. This component consists of a membrane that separates the exhaust air from the incoming air and a housing to contain the membrane assembly. A humidity concentration gradient across the membrane serves to drive water vapor from the high concentration side to the low concentration side of the membrane. The membrane is selectively permeable to water vapor, and is not permeable to oxygen. In this way, the oxygen is not removed from the incoming air stream, but is supplied to the fuel cell stack. A commercially available humidity exchanger that can be used in one embodiment is PERMAPURE model No. FC300-1660-15ABS.

The humidity exchange component may include one or more a humidity buffers. The humidity buffers may be a gel or in a solution. The humidity exchange component may include a tray or container that holds the humidity buffer. The tray may be disposed within the housing. A space between the fuel cell electrolyte solution and the humidity buffer solution may be occupied by a gas phase. The gas phase can contact with both the fuel cell electrolyte solution and the humidity buffer. Water may pass from the humidity buffer to the fuel cell electrolyte solution, or from the fuel cell electrolyte solution to the humidity buffer solution as needed. Accordingly, as the fuel cell electrolyte solution loses water, drawing replacement water from the humidity buffer via the intervening gas phase compensates the water loss. Furthermore, the surrounding gas phase may maintain a substantially constant relative humidity because it may draw replacement water from the humidity buffer solution. Conversely, if the fuel cell collects, absorbs, or creates excess water, the excess can be expelled from the electrolyte solution by vaporizing it into the surrounding gas phase. Furthermore, the surrounding gas phase maintains a substantially constant relative humidity because it releases water to the air gas stream.

Suitable humidity buffer materials can provide a stable, fixed or set humidity level. The humidity level can be selected to be suitable for a rechargeable fuel cell. Examples include saturated solutions of organic or inorganic salts, drying agent solutions, polymer gels, and inorganic colloids. Suitable humidity buffer solutions can comprise one or more alkaline earth metal salt, which may be a halide, sulfate, carbonate, nitrate, or caboxylate. Suitable salt solutions may include one or more of CaSO₄, LiCl, CH₃COOK, MgCl₂, KCO₃, Mg (NO₃)₂, NaBr, CoCl₂, NaNO₂, SrCl₂, NaNO₃, NaCl, KBr, (NH₄)₂SO₄, KCl, Sr(NO₃)₂, BaCl₂, KNO₃, or K₂SO₄. The humidity buffer solution may be a saturated solution. In one embodiment, the saturated solution may consist essentially of one or more of CaSO₄, LiCl, CH₃COOK, MgCl₂, KCO₃, Mg (NO₃)₂, NaBr, CoCl₂, NaNO₂, SrCl₂, NaNO₃, NaCl, KBr, (NH₄)₂SO₄, KCl, Sr(NO₃)₂, BaCl₂, KNO₃, or K₂SO₄.

These compositions may produce equilibrium humidities during use that are greater that 50 percent of the equilibrium humidity of 6M KOH. In one embodiment, the equilibrium humidity is in a range of from about 50 percent to about 60 percent, from about 60 percent to about 65 percent, from about 65 percent to about 75 percent, from about 75 percent to about 85 percent, or from about 85 percent to about 90 percent of the equilibrium humidity of 6M KOH. Such substances can generate a local environment having a humidity that is stable and suitable for maintaining water balance in a rechargeable fuel cell. Table 1 sets forth a plurality of humidity buffer solutions that can provide equilibrium humidities in a suitable range of humidities.

TABLE 1
Equilibrium humidity of saturated salt solutions

| SALT | 25° C. | 30° C. |
|---|---|---|
| CaSO₄ | <0.01 | <0.01 |
| LiCl | 0.112 | 0.115 |
| CH₃COOK | 0.227 | 0.225 |
| MgCl₂ | 0.328 | 0.329 |
| KCO₃ | 0.432 | 0.447 |
| Mg(NO₃)₂ | 0.529 | 0.52 |
| NaBr | 0.576 | 0.574 |
| CoCl₂ | 0.649 | — |
| NaNO₂ | 0.643 | 0.649 |
| SrCl₂ | 0.709 | — |
| NaNO₃ | 0.743 | — |
| NaCl | 0.753 | 0.769 |
| KBr | 0.809 | — |
| (NH₄)₂SO₄ | 0.81 | — |
| KCl | 0.843 | 0.85 |
| Sr(NO₃)₂ | 0.851 | — |
| BaCl₂ | 0.902 | 0.92 |
| KNO₃ | 0.936 | — |
| K₂SO₄ | 0.973 | 0.977 |

The humidity buffer solution may further include a hydrophilic additive. Suitable hydrophilic additives may include a polyacrylate, for example, sodium polyacrylate (PAA Na) CAS#: 9003-04-7. Additionally or alternatively, other suitable hydrophilic additives may include one or more alcohols, amines, ethers, or cellulosics. Suitable alcohols may be polyols, such as polyethylene glycol. In one embodiment, the hydrophilic additive may include one or more of glycerin, carboxymethyl cellulose (CMC), or polyethylene oxide. In one embodiment, the hydrophilic additive may include one or more of polyacrylamide, polyvinyl alcohol or poly(vinyl acetate). The hydrophilic additives may include one or more functional groups that are effective for bonding with water. Suitable functional groups may include one or more of OH—, carboxyl, ether, and NH— functional groups. In one embodiment, more than one type of functional group is present on a single molecule.

The PAA Na, glycerin, polyethylene oxide, carboxymethyl cellulose (CMC), alcohols and amine additives may be soluble in water. The chemical formula for PAA Na is:

[CH₂—CH(COONa)]ₙ.

The KOH/PAA Na/water humidity buffer solution may control the humidity level in the air gas stream because when water evaporation increases, more water vapor is formed. The KOH and PAA Na concentrations increase within the humidity buffer solution. As a consequence, evaporation of water from the humidity buffer solution is decreased because the equilibrium vapor pressure for water favors retention of water in the humidity buffer solution. The water concentration increase in the humidity buffer solution continues until the vapor pressure favors water evaporation. This self-regulating water/water vapor dynamic may reduce or prevent a risk of the electrochemical cell drying out. This aspect may maintain a water balance in the cell within a determined range. For some embodiments, the PAA Na shows such effect up to about 800 times its weight in water.

The chemical formula for carboxymethyl cellulose (CMC) is:

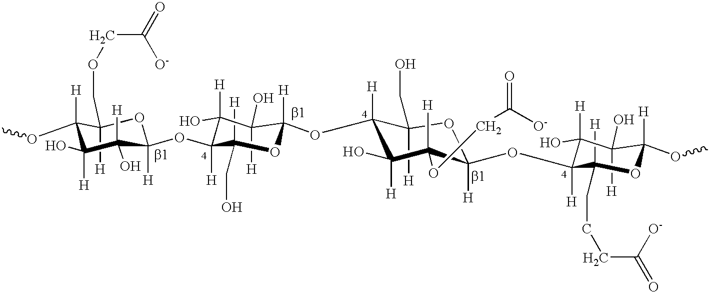

Suitable hydrophilic additives may have a molecular weight of up to about 3,000,000. In one embodiment, the hydrophilic additive average molecular weight may be in a range of from about 50,000 to about 500,000; from about 500,000 to about 750,000; from about 750,000 to about 1,000,000; from about 1,000,000to about 1,500,000; from about 1,500,000 to about 2,000,000; from about 2,000,000 to about 2,500,000; from about 2,500,000 to about 2,750,000; or from about 2,750,000 to about 3,000,000.

The hydrophilic additive may be present in the humidity buffer solution in a concentration effective for reducing water evaporation from the electrochemical cell. The hydrophilic additives may be present in the humidity buffer solution in an amount of up to about 95 weight percent based on the weight of the humidity buffer solution. In one embodiment, the hydrophilic additive may be present in the humidity buffer solution in an amount in a range of from about 0.5 weight percent to about 1.5 weight percent, from about 1.5 weight percent to about 2.5 weight percent, from about 2.5 weight percent to about 5 weight percent, from about 5 weight percent to about 7.5 weight percent, from about 7.5 weight percent to about 15 weight percent, from about 15 weight percent to about 25 weight percent, from about 25 weight percent to about 50 weight percent, from about 50 weight percent to about 65 weight percent, from about 65 weight percent to about 80 weight percent, or from about 80 weight percent to about 95 weight percent based on the weight of the humidity buffer solution.

During use, the hydrophilic additives may absorb water vapor from air and may retain the water in the humidity buffer solution. The presence of the hydrophilic additives in the humidity buffer solution may reduce the equilibrium vapor pressure of the humidity buffer solution. A relatively lower equilibrium vapor pressure may retain relatively more water in the humidity buffer solution as liquid.

During discharge process, water is consumed and air/oxidant is supplied to the air electrode to generate hydroxyl ions. In one embodiment, before supplying a flow of air/oxidant to the air electrode from the ambient environment, carbon dioxide may be removed from the flow of air/oxidant to avoid interaction between the carbon dioxide and the alkaline electrolyte.

During use of the apparatus as a fuel cell, a voltage potential can be applied between the anode and the third electrode of the fuel cell, and the electrochemical reaction can be reversed to charge the fuel cell or metal/air battery. During charging, hydrogen is stored in the anode and oxygen is produced at the air electrode, the third electrode can spatially remove the locus for the generation of oxidation away from the second electrode/anode. Generated oxygen may be released to the atmosphere through the air electrode. The stored hydrogen can react with air/oxidant to generate electricity and water during discharge. The mechanism of a fuel cell or metal/air battery may be as follows:

In charging process:
negative electrode: 4M+4H₂O+4e→4MH+4OH⁻
frame third electrode: 4OH⁻→O₂+2H₂O+4e
total electrolysis reaction: 4M+2H₂O→4MH+O₂

In discharging process:
negative electrode: 4MH+4OH⁻+4e→4M+4H₂O
positive electrode: O₂+2H₂O+4e→4OH⁻
total cell reaction: 4MH+O₂→4M+2H₂O

The air electrode may be used during the charge cycle, but may not be sufficient in some instances. For example, the air electrode may deteriorate if used to charge the fuel cell. Thus, the third electrode may be utilized as a separate oxygen generation electrode. The charge process takes place between the anode and the third electrode and the discharge process takes place between the anode and the air electrode. According to embodiments of the invention, the third electrode may be utilized to extend the cycle life over traditional structures by chemically and mechanically protecting the air electrode from degradation during recharge. Therefore, the air electrode can be free from damage during the oxygen evolution reaction.

Operation of the fuel cell at high temperature may be problematic if the temperature is high enough for water in the fuel cell to vaporize. High temperature may cause the membrane between the two electrodes to dry and lose conductivity. The fuel cell may need water in the electrolyte as well as water at the anode. Water may be generated at the air electrode. The more power a fuel cell makes, the faster the air electrode produces water and the warmer the fuel cell becomes. Because the fuel cell embodiments described herein are not necessarily closed containers, the heat generated at the air electrode may lead to evaporation of some water from the cell.

The outside temperature and humidity may influence the water management inside the fuel cell. If, under humid conditions, a fuel cell has too much water at the air electrode, oxygen cannot get to the air electrode, and the fuel cell may shut down as a result of flooding. In a dry climate, the heat from the fuel cell operation may parch the air electrode, starving it of water, and may stop the device from operating. In other words, too much water in the fuel cell may flood the air electrode, stopping the reaction and insufficient water may result losing the membrane ability to conduct OH⁻ across the fuel cell.

During the charge reaction, when the third electrode includes nickel hydroxide or supercapacitor electrode is not fully charged, the charge reaction performs as follows:

Ni(OH)+OH⁻→NiOOH+H₂O+e⁻

No oxygen releases from the third electrode and water loss may be reduced. After the third electrode is fully charged, the third electrode performs as a metal electrode of a conventional rechargeable fuel cell, releases the generated oxygen.

4OH⁻→2H₂O+O₂+4e⁻

In this way, water loss may be reduced by using nickel hydroxide or supercapacitor electrode, while the electrode is not in a fully charged state or condition. Additionally, the fuel cell has a desirable energy efficiency, as charge voltage is relatively lower.

Naturally, the discharge of the cell may be carried out using the anode and the air electrode. In one embodiment, the discharge of the cell may be carried out using the anode and the third electrode. In one embodiment, the discharge of the fuel cell may be carried out using the anode, the air electrode and the third electrode. So, current can be drawn from the air electrode, the third electrode or both. If current is to be drawn off of both the third electrode and the air electrode, the draw can be simultaneous or can be alternating between electrodes.

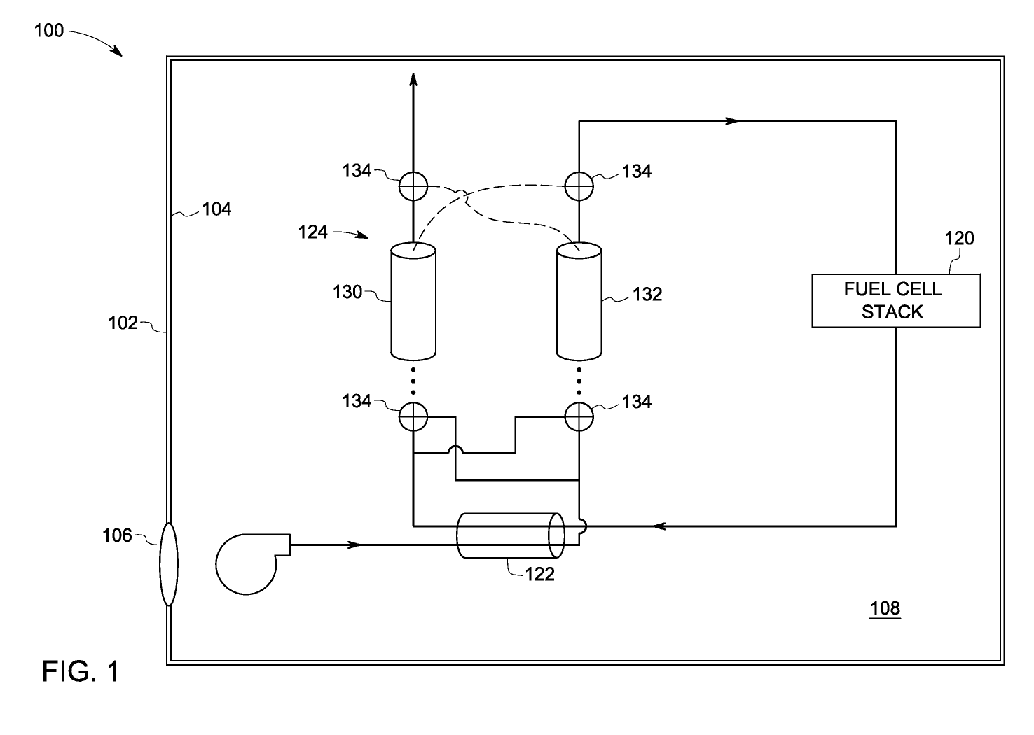

With reference to FIG. 1, an apparatus 100 includes a housing 102. The housing has an inner surface 104 and at least one ingress port or aperture 106 that allows ambient air to flow into a volume 108 defined by the housing inner surface. A fuel cell stack 120 includes a plurality of fuel cells (not shown individually) and is disposed within the housing volume with a humidity exchange component 122 and a gas scrubber 124. In an alternative embodiment, one or both of the humidity exchange component and the gas scrubber are located outside of the housing volume.

The gas scrubber can include a plurality of gas scrubber modules (130, 134) and a crossover valve system 136. The illustrated apparatus has a first and a second operating mode, and a controller (not shown) can switch between the operating modes.

During the first operation mode, a first one of the plurality of gas scrubber modules 130 reduces a carbon dioxide content level from the air gas stream pumped through the humidity exchange component and the active material of the second one of the plurality of gas scrubber modules 134 is regenerated by transferring heat from the flow of hot exhaust air coming from the electrochemical cell to the second one of the plurality of gas scrubber module. Similarly, during the second operation mode, the second one of the plurality of gas scrubber modules reduces carbon dioxide content level from the air gas stream and the active material of the first one of the plurality of gas scrubber modules is regenerated by transferring heat from the flow of hot exhaust air coming from the electrochemical cell. Thus each gas scrubber module alternately absorbs carbon dioxide from the air gas stream and regenerates the active material.

A heat transfer device (not shown) can aid in the heat transfer between the modules. The crossover valve system responds to controller inputs by switching the air gas stream flow path to flow from the first one of the plurality of gas scrubber modules to the second one of the plurality of gas scrubber modules in response to a change of operating modes to and from the first operation mode and the second operation mode. The crossover valve system also can respond to controller inputs by flowing the air gas stream through all of the plurality of gas scrubber modules.

The air gas stream can flow through the humidity exchange component prior to flowing through the gas scrubber component. While passing through humidity exchange component, the hot exhaust air transfers water vapor to the air stream supplying to the electrochemical. This configuration may increase water retention in the apparatus, and may decrease water loss through exhaust gas venting.

In one embodiment, both gas scrubber modules can operate simultaneously and no regeneration takes place. Such an operating mode may be useful for a situation with an increased or sudden power demand. The power demand operating mode would naturally have a finite period before the carbon dioxide scrubbing capacity of both gas scrubber modules was exhausted.

### EXAMPLES

### Example 1

A series of cells are produced and arranged into stack of 100 kW. The air stream having carbon dioxide content equal to 400-500 ppm is supplied to the electrochemical cell through humidity exchange component and one of the plurality of scrubber module at a rate of 0.29 mol/s. The carbon dioxide content in air stream coming out of the scrubber module is 10 ppm. The hot exhaust air coming from the electrochemical cell passes through the humidity exchange component and the second scrubber module for regeneration of the second scrubber module. The relative humidity of humidity exchange component is 60%. The cycle time of scrubber module is 2 hour and run time of the system is 10 hour. The system is evaluated for characteristics and properties. The characteristics and properties are listed in Table 2.

TABLE 2
Characteristics and Properties.

| | | | |
|---|---|---|---|
| 1. | Stack size | 100 | kWh |
| 2. | Stack energy density | 380 | Wh/L |
| 3. | Total System volume | 347 | L |
| 4. | RFC system energy density | 288 | Wh/L |

The embodiments described herein may be examples of compositions, structures, systems, and methods having elements corresponding to the elements of the invention recited in the appended claims. This written description may enable those of ordinary skill in the art to make and use embodiments having alternative elements that likewise correspond to the elements of the invention recited in the claims. The scope of the invention thus includes compositions, structures, systems and methods that do not differ from the literal language of the claims, and further includes other structures, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed is:

1. An apparatus, comprising;
a housing comprising an electrochemical energy conversion device, the electrochemical energy conversion device having a plurality of electrodes, wherein at least one electrode is configured to receive an air gas stream flowing thereto;
a humidity exchange component capable of controlling a humidity level in the air gas stream flowing toward the electrode; and
a gas scrubber component comprising an active material capable of reducing a carbon dioxide content level from the air gas stream.

2. The apparatus as defined in claim 1, wherein the plurality of electrodes comprises an anode, a cathode, and a third electrode.

3. The apparatus as defined in claim 2, wherein the third electrode functions to locate the generation of oxygen spatially distant from the anode.

4. The apparatus as defined in claim 2, wherein a separator membrane is disposed between the housing and the cathode, wherein the separator membrane allows air to pass into the housing but blocks liquid from flowing out of the housing.

5. The apparatus as defined in claim 2, wherein the anode comprises a hydrogen storage material.

6. The apparatus as defined in claim 1, wherein the housing further comprises a base operable to hold at least one of the plurality of electrodes, a tray disposed proximate to the base, the tray defining one or more spaces for containing the at least one humidity-controlling component, and a cover for the tray that is operable to reduce spillage of the humidity-controlling component from the one or more spaces.

7. The apparatus as defined in claim 1, further comprising a vent configured to allow at least one air gas stream to exfiltrate the housing.

8. The apparatus as defined in claim 1, wherein the humidity-controlling component comprises a saturated aqueous solution.

9. The apparatus as defined in claim 1, wherein the humidity-controlling component comprises one or more solutions selected from the group consisting of: lithium chloride, potassium acetate, magnesium chloride, potassium carbonate, magnesium nitrate, sodium bromide, cobalt chloride, sodium nitrite, strontium chloride, sodium nitrate, sodium chloride, potassium bromide, ammonium sulfate, potassium chloride, strontium nitrate, barium chloride, potassium nitrate, and potassium sulfate.

10. The apparatus as defined in claim 8, wherein the humidity controlling solution is contained within a material selected from the group consisting of a porous particulate substance, a zeolite, a natural clay, and an inorganic gel.

11. The apparatus as defined in claim 8, wherein the humidity controlling solution is contained within a material comprising an organic polymer gel or a porous membrane.

12. The apparatus as defined in claim 1, wherein the humidity-controlling component comprises a metal salt.

13. The apparatus as defined in claim 12, wherein the metal salt comprises an alkali metal halide or a rare earth metal halide.

14. The apparatus as defined in claim 12, wherein the metal salt comprises a metal nitrate, or a metal sulfate, or a metal phosphate.

15. The apparatus as defined in claim 1, wherein the active material comprises an amine functional moiety or an imine functional moiety.

16. The apparatus as defined in claim 15, wherein the active material comprises an amine-functionalized polymer, an amine-functionalized copolymer, or a blend of the amine-functionalized polymer and the amine-functionalized copolymer.

17. The apparatus as defined in claim 15, wherein
the amine functional moiety comprises one or more of monoethanolamine, diethanolamine, or triethanolamine; or,
the imine functional moiety comprises polyethyleneimine.

18. The apparatus as defined in claim 1, wherein the active material comprises one or more amidine functional moiety.

19. The apparatus as defined in claim 1, wherein the active material comprises an amidine-functionalized polymer, an amidine-functionalized copolymer, or a blend of the amidine-functionalized polymer and the amidine-functionalized copolymer.

20. The apparatus as defined in claim 19, wherein one or both of the amidine-functionalized polymer and the amidine-functionalized copolymer comprises polystyrene, polyacrylate, polymethacrylate, polyimide, polyetherimide, polysulphone, polyarylene oxide, or polycarbonate.

21. The apparatus as defined in claim 1, wherein the active material comprises 1,8-diazabicyclo undec-7-ene, tetrahydro pyrimidine, or N-methyl tetrahydro pyrimidine.

22. The apparatus as defined in claim 1, wherein the active material is supported on a surface of a porous material.

23. The apparatus as defined in claim 1, wherein the gas scrubber comprises a plurality of gas scrubber modules and a crossover valve system,
wherein a first one of the plurality of gas scrubber modules is capable of reducing a carbon dioxide content level from the air gas stream during a first operation mode, and a second one of the plurality of gas scrubber modules is capable of reducing a carbon dioxide content level from the air gas stream during a second operation mode and
the crossover valve system is capable of responding to controller inputs by switching the air gas stream flow path to flow from the first one of the plurality of gas scrubber modules to the second one of the plurality of gas scrubber modules in response to a change of operating modes to and from the first operation mode and the second operation mode.

24. The apparatus as defined in claim 23, wherein during each operation mode heat from a flow of hot exhaust air coming from the electrochemical cell transfers to the one of the plurality of gas scrubber modules to regenerate the active material.

25. The apparatus as defined in claim 23, further comprising a supplemental heater in thermal communication with the active material that is operable to supplement heat coming from the hot exhaust air flow to regenerate the active material.

26. The apparatus as defined in claim 23, wherein the crossover valve system is further capable of responding to controller inputs by flowing the air gas stream through all of the plurality of gas scrubber modules.

27. The apparatus as defined in claim 1, wherein the air gas stream flows through the humidity exchange component prior to flowing through the gas scrubber component so that there is a transfer of moisture from an outflow of stack exhaust air to the incoming air gas stream.

28. A method, comprising:
contacting ambient air to a humidity buffer to control the humidity level of an air gas stream flowing from the ambient air toward at least one of plurality of electrode in an electrochemical cell;
contacting the air gas stream to an active material layer, wherein the ambient air comprises a target gas;
binding the target gas to the active material layer; and
flowing the air gas stream, which is free of the target gas, toward the electrode.

29. The method as defined in claim 28, wherein the target gas is carbon dioxide.

30. The method as defined in claim 28, further comprising maintaining a relative humidity of the air gas stream within the electrochemical cell in a range of from about 70 percent to 85 percent.

31. The method as defined in claim 28, further comprising generating hydrogen, and storing the hydrogen in an anode.

32. The method as defined in claim 28, further comprising contacting the air gas stream to an active material layer in a first gas scrubber module during a first operation mode, and contacting the air gas stream to an active material layer in a second gas scrubber module during a second operation mode, and switching from the first operation mode to the second operation mode.

33. The method as defined in claim 32, further comprising regenerating the active material layer in the first gas scrubber during the second operation mode and regenerating the active material layer in the second gas scrubber during the first operation mode.

34. The method as defined in claim 33, wherein regenerating comprises supplying thermal energy to the active material layers in the first gas scrubber, the second gas scrubber, or both the first and the second gas scrubbers.

35. The method as defined in claim 34, further comprising actuating an electrically powered heater that is in thermal communication with the active material layer, and wherein the thermal regeneration is achieved by the thermal energy supplied by the electrically powered heater.

36. The method as defined in claim 35, further comprising supplying electrical energy from the fuel cell system to the electrically powered heater.

37. The method as defined in claim 32, further comprising switching to a power demand mode and contacting the air gas stream to active material layers in both the first gas scrubber module and the second gas scrubber module simultaneously.

38. An apparatus, comprising:
an electrochemical cell comprising an air electrode configured to receive an intake air gas stream;
means for maintaining a defined relative humidity of the intake air gas stream to be in a range of from about 50 percent to about 90 percent; and
means for reducing or eliminating carbon dioxide from the air gas stream.
